(19) United States
(12) Patent Application Publication
(10) Pub. No.: US 2002/0190957 A1
(43) Pub. Date: Dec. 19, 2002

(54) Portable keyboard for use with hand-held computer

(76) Inventors: Soon Lee, Seoul (KR); Jae-Wook Moon, Seoul (JP); Yong-Seong Lee, Anyang-Si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/155,829

(22) Filed: May 22, 2002

(30) Foreign Application Priority Data
May 25, 2001 (KR) 29118/2001

(51) Int. Cl. G09G 5/00

(52) U.S. Cl. 345/169

(57) ABSTRACT

Disclosed is a portable keyboard which can be used with a portable computers, such as hand-held computers. The keyboard has a housing comprises a housing, a keyboard including a plurality of key buttons and a circuit unit installed in the housing for generating electrical signals corresponding to key buttons pressed. The keyboard also includes an engagement structure and a connector to the portable computer. The engagement structure is configured to receive and hold the portable computer and keep electrical connection therewith trough the connector.

### BACKGROUND OF THE INVENTION

1. Field of the Invention

The present invention relates to a keyboard for a computer. More specifically, the present invention pertains to a portable keyboard for use with hand-held computers or electronic devices that do not have integrated keyboards.

2. Description of the Related Technology

Recently, palmtop or hand-held computers have been very popular and widely used. Most of hand-held computers do not have their own integrated keyboards dedicated to alphanumeric characters. Rather, these hand-held computers have a few or several key buttons for some essential functions other than inputting characters and symbols. Thus, various alphanumerical inputting schemes, which do not use a keyboard, are used in these small computers. One method is handwriting letters on a touch screen. When a user hand-writes characters and symbols on a character recognition area of the screen, the computer recognizes them and generates signals for the input of the written characters as if they were typed in with a keyboard. Although this method provides the convenience of handwriting, the letter recognition rate is often slow and the letters may be erroneously recognized.

Another way of inputting desired letters, numbers and symbols into such computers is touching keys displayed on a touch screen panel. A display screen displays a plurality of key buttons, which overall look like a keyboard for alphanumeric characters. When the user touches a key with a pin or fingertip, a character corresponding to the button is inputted. This method may be speedier than handwriting recognition but is still much slower that actual typing with a keyboard. Also, key buttons are generally too small, which makes speedy input difficult.

An external keyboard may also be utilized while it is connected to such a computer. Such external keyboards generally have poor mobility due to their large size. Collapsible or foldable keyboards have been commercialized. However, there is still limitation on the mobility of those keyboards. Furthermore, they are disadvantageous because a flat space is needed to place a keyboard on.

### SUMMARY OF CERTAIN INVENTIVE ASPECTS

An aspect of the present invention provides a keyboard integrally mountable into a portable computer system. Another aspect of the present invention provides a keyboard which can be connected to and then integrated with a portable computer system without an external or extra cable. A further aspect of the present invention provides a portable computer system, wherein when a keyboard is connected to a portable computer system, the display panel of the computer displays a screen keyboard with keys other than those available from the connected keyboard.

According to an aspect of the present invention, there is provided an external keyboard apparatus which is attachable to a portable information system including a case and a first connector fixed to a predetermined location of the case and connected with an external device. The external keyboard apparatus comprises a housing; a keyboard including a plurality of key buttons exposed toward an outer side of the housing; and a circuit unit installed in the housing for generating information corresponding to any one of the key buttons pressed by a user and transmitting/receiving data to/from the portable information system, wherein the circuit unit includes a second connector which is fixed to a predetermined location of the housing, exposed to the outer side of the housing, and engaged and connected with the first connector.

According to another aspect of the present invention, there is also provided a portable information system which comprises a main body which includes a case and a first connector fixed to a predetermined location of the case and connected with an external device; and an external keyboard apparatus adapted to be connected with the main body, which includes a housing, a keyboard including a plurality of key buttons exposed toward an outer side of the housing, and a circuit unit installed in the housing for generating information corresponding to any one of the key buttons pressed by a user and transmitting/receiving data to/from the portable information system, wherein the circuit unit includes a second connector which is fixed to a predetermined location of the housing, exposed to the outer side of the housing, and engaged and connected with the first connector.

Another aspect of the present invention provides an input apparatus for use with an electronic device. The apparatus comprises: a housing comprising a surface and a structure configured to receive and engage with a portion of an electronic device; a plurality of key buttons arranged on the surface of the housing, each key button is configured to generate an electrical signal when pressed; and a connector disposed in the housing and configured to electrically connect with the electronic device so that electrical signals generated in the apparatus can be transmitted to the electronic device. The structure is configured to interlock with a mating structure of the electronic device. The connector is configured to form connection with the electronic device when the structure is engaged with the portion of the electronic device. The apparatus further comprises a control circuit configured to control operation of transmission of electric signals. The control circuit comprises a processor and a memory.

A further aspect of the present invention provides an input device for use with a hand-held computer. The input device comprises: means for holding a hand-held computer; means for generating signals for alphanumeric characters; and means for transferring the signals of alphanumeric characters to the hand-held computer while the hand-held computer is held by the holding means. The holding means comprises a recess to receive a portion of the hand-held computer. The holding means comprises a snap lock to interlock with a mating structure of the hand-held computer. The signal generating means comprises a plurality of key buttons. The signal transferring means comprises an electrical connector for connecting the input device with the hand-held computer. The signal transferring means is absent of an external cord.

A still further aspect of the present invention provides a portable computer. The portable computer comprises: a display unit comprising a display panel and a connector for connecting with an input device; and a detachable keyboard comprising a mount for the display unit, wherein the mount comprising a connector configured to connect with the connector of the display unit. The mount further comprises a structure configured to hold the display unit. The display unit further comprises a portion shaped to be engaged with the mount. The display unit further comprises a central control unit (CPU) and a memory connected to the CPU. The display panel comprises a touch screen input device. The display unit is programmed to receive inputs from the keyboard and from a touch screen. The display unit is a hand-held computer. When the display unit is connected to the keyboard, the display unit is configured to display keys not appearing in the keyboard for inputting by touching the screen.

A still further aspect of the present invention provides a method of inputting data to an electronic device. The method comprises: interlocking an input device comprising a plurality of key buttons with an electronic device comprising a display panel; electrically connecting the input device and the electronic device; and pressing a key button of the input device, thereby inputting a character or symbol corresponding to the pressed key button into the electronic device. The electrical connection is automatically carried out by the interlocking of the input device with the electronic device. When connecting the input device and electronic device, the display panel displays a plurality of keys for inputting by touching them, and wherein the plurality of keys displayed are those which are not available in the input device. The method further comprises touching a key displayed on the display panel, thereby inputting a character or symbol corresponding to the touched key into the electronic device.

### BRIEF DESCRIPTION OF THE DRAWINGS

The above and other features of the present invention will become apparent from the following description of preferred embodiments given in conjunction with the accompanying drawings, in which:

FIGS. 1a and 1b are front and side views of a hand-held computer with a keyboard in accordance with a preferred embodiment of the present invention;

FIG. 2 is a partial cut-away side view of the computer and keyboard, illustrating the engagement therebetween;

FIG. 3 is a block diagram illustrating the configuration of the hand-held computer shown in FIG. 1;

FIG. 4 is a block diagram illustrating the configuration of the keyboard shown in FIG. 1;

FIG. 5 is a flowchart illustrating a key input operation among a basic input/output system (BIOS) of the computer shown in FIG. 1;

FIG. 6 is a flowchart illustrating a key input operation of the keyboard shown in FIG. 1; and

FIG. 7 illustrates that the display panel displays symbols and characters for touch inputs which are not available from the keyboard.

### DETAILED DESCRIPTION OF CERTAIN INVENTIVE EMBODIMENTS

Hereinafter, preferred embodiments of the present invention will be described in detail with reference to the accompanying drawings. For the purpose of description, the preferred embodiments are discussed in terms of a hand-held computer, which is also referred to as a personal digital assistant (PDA). However, the present invention is not limited to hand-held computer or PDA. The present invention can be applicable to any electronic or electrical devices needing inputs of character or symbols.

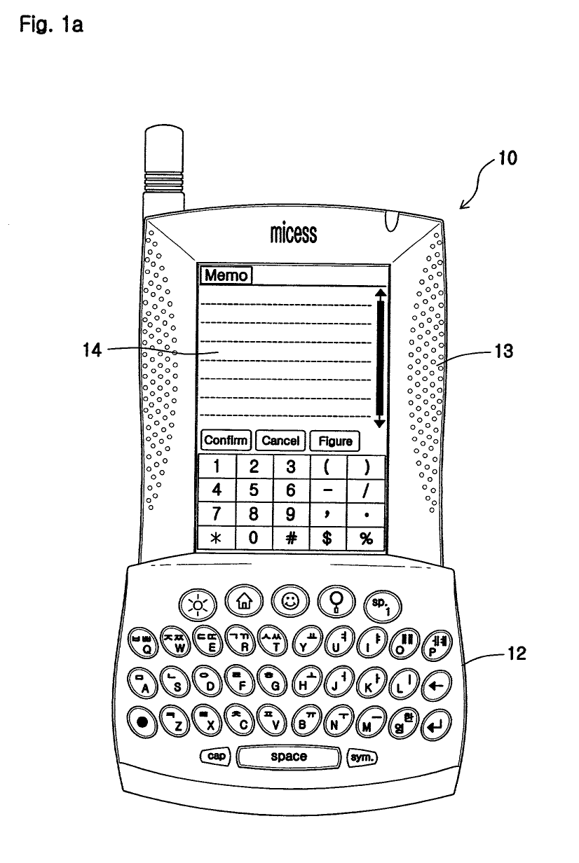

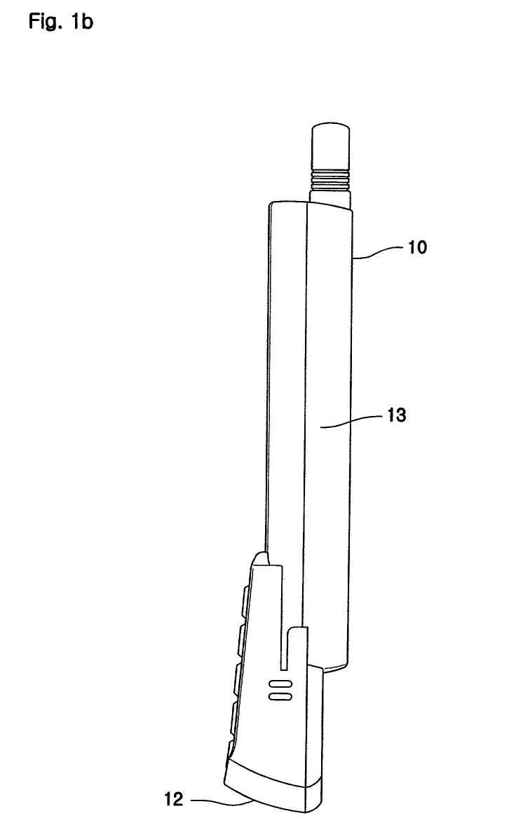

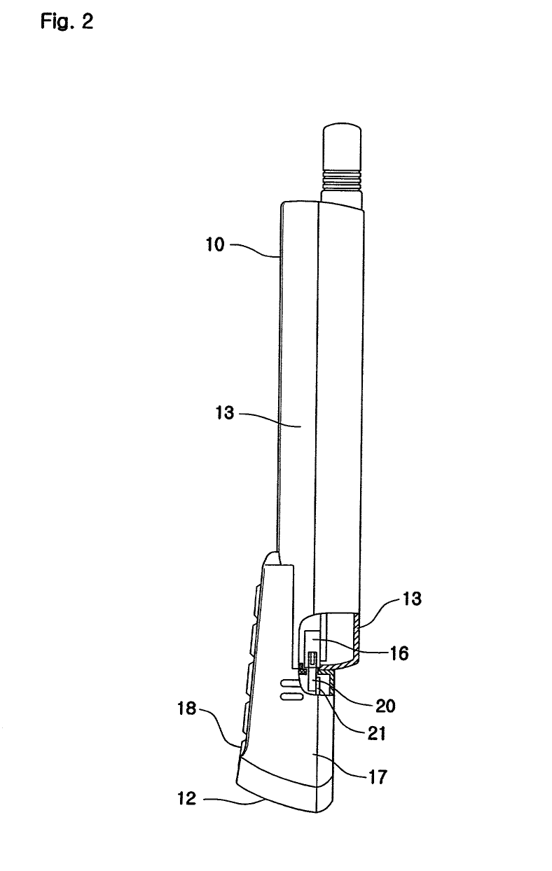

Referring to FIGS. 1a, 1b and 2, an external keyboard 12 is engaged and connected to a PDA 10. The PDA 10 includes a case 13 and a touch screen panel or device 14. The touch screen device 14 is provided with a display panel such as liquid crystal display (LCD) and a touch sensor panel. The touch screen device 14 is also provided with a screen keyboard and is divided into respective regions to which functions of input keys are assigned by section lines. When a user touches the relevant regions with a predetermined pen (generally, a plastic rod) or a finger of the user, letters, numbers and/or special symbols corresponding to the regions (hereinafter, referred to as “symbols”) can be inputted.

In a case where each area of the regions corresponding to the respective symbols becomes small by dividing a screen of the touch screen panel 14 into small regions, it is difficult for the user to input the symbols with his/her finger. However, if each area of the regions becomes larger, kinds of the symbols capable of being inputted through a single screen of the touch screen panel are restricted. Thus, the user should input the symbols while alternating different configurations of the regions with one another. As understood from the following description, when the external keyboard apparatus 12 is utilized, only a small number of keys for complementing the external keyboard apparatus 12 will be necessary on the touch screen device 14. Therefore, since each area of the regions to which the respective symbols are assigned becomes large, the convenient input of the symbols can be obtained.

Although FIG. 1a shows the touch screen panel on which a numeric keyboard for complementing the external keyboard apparatus 12 is prepared, the present invention is not limited thereto. The touch screen device may also include a keyboard with other kinds of keys arranged thereon according to an application program.

Referring to FIG. 2, the PDA 10 is provided at a lower end portion thereof with a connector 16 (generally, a RS232C serial communication connector) for connection with external devices. In general, the connector 16 is connected with a connecting cord (a complementary connector to be engaged with the connector 16 is provided at an end of the cord) for connection with the external devices.

In order to overcome inconvenience that the user should input the symbols with only the touch screen panel 14, the keyboard apparatus 12 is mounted in the PDA 10. The keyboard apparatus 12 is provided with a plurality of key buttons 18 exposed toward an outer side of a housing 17. The symbols are assigned to and printed onto the respective key buttons, respectively. Some key buttons (e.g., a spacebar button) may be prepared to have large sizes in consideration of high frequency of use thereof. The keyboard apparatus shown in FIG. 1a can be used to input Korean and English alphabets. Of course, the present invention is not limited thereto. Various layouts of the key buttons of the keyboard apparatus 12 (for example, 2-bulsik or 3-bulsik keyboard in case of the Korean alphabet, and QWERTY or Dvorak keyboard in case of the English alphabet) can be made. Alternatively, a keypad for inputting only numbers may be utilized.

Referring again to FIG. 2, the keyboard apparatus 12 is provided at an inner side thereof with a connector 20. The connector 20 is fixed to a printed circuit board 21 in the keyboard apparatus. The connector 20 can be also engaged with the connector 16 provided in the PDA 10. With such a constitution, the keyboard apparatus 12 can be attached and connected to the PDA 10 without need to use an additional connection cable.

Although not specifically shown in these figures, it is preferred that grooves and protrusions, which are engaged with each other so that firm engagement can be kept between the PDA 10 and the keyboard apparatus 12, be beforehand prepared on the case 13 of the PDA 10 and the housing 17 of the keyboard apparatus 12. It can be understood by the skilled in the art that engagement structures (e.g., interference fit, snap fit and the like) as well as those using grooves and protrusions may be utilized to maintain the firm engagement between the PDA and the keyboard apparatus. With such a constitution, the case 13 and the housing 17 can be engaged with or separated from each other, that is, selectively engaged with each other. Furthermore, even though external force other than separation force will be applied, a state where the keyboard apparatus 12 is engaged with the PDA 10 is maintained so that they can be integrally coupled or integrated with each other.

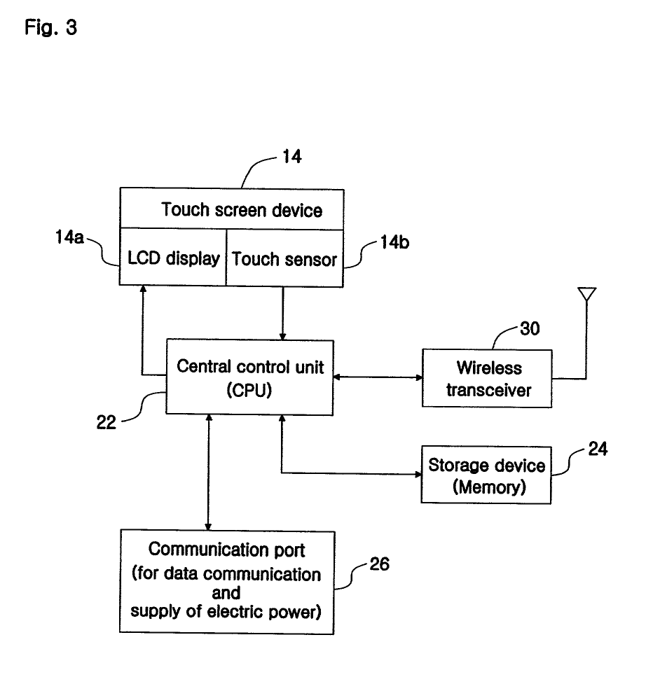

Referring to FIG. 3, the PDA 10 includes a central control unit 22; and the touch screen device 14, a storage device (memory) 24, and a communication port 26 which are connected with the central control unit 22. The central control unit 22 includes a CPU (for example, 32-bit RICS processor (ARM7TMI)) and peripheral circuits. As described above, the touch screen device 14 includes a liquid crystal display panel 14a and a touch sensor panel 14b. The storage device or memory 24 is composed of 4 Mbyte flash memory and a 2 Mbyte RAM, for example. A basic input/output system (BIOS), an operating system, a driver program, an application program and the like for the PDA 10 are stored into the flash memory. The RAM is used as a data storage space and a stack used for executing the programs. The communication port 26 is used to perform the communication with the external devices, for example, the keyboard apparatus 12. Data and control signals are transmitted and received through the communication port 26. Such a device as the keyboard device 12 may be supplied with electric power through the communication port 26. The communication port 26 is provided with the connector 16. In addition, the PDA may further include a power switch and a key button, such as a cursor key button, for performing an auxiliary input function.

Recently, a wireless communication function has been incorporated into the PDA 10 as wireless communication technology has developed. By way of example, there is a product which has been developed by the present inventor(s) and sold under the trademark MICESS or TWM □. The PDA 10 further includes a wireless transceiver 30. Since data can be transmitted and received through the wireless transceiver 30, the PDA 10 can be used to transmit and receive electronic mails, to perform chatting and Internet surfing, and the like.

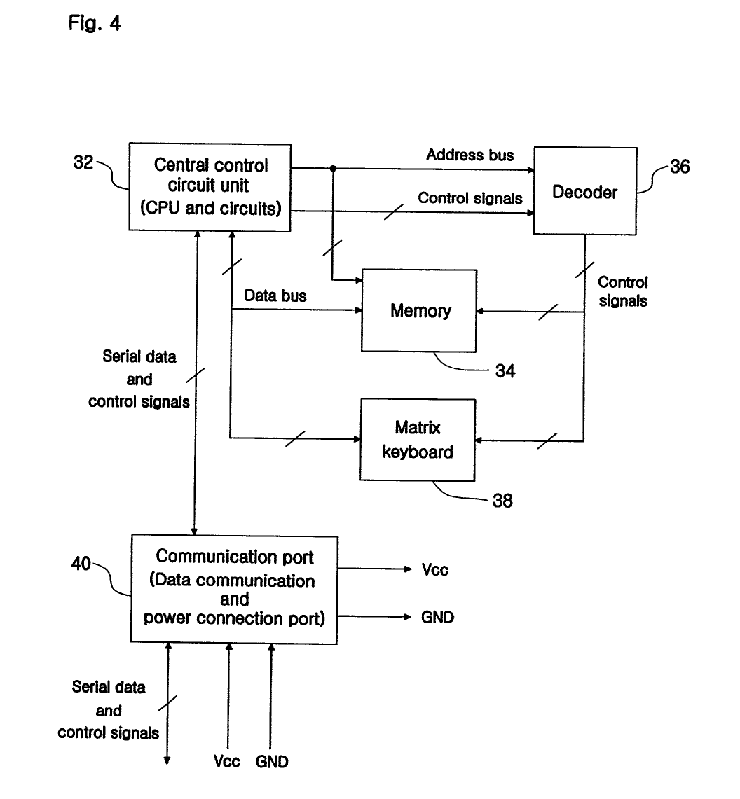

Referring to FIG. 4, the keyboard apparatus 12 includes a central control circuit unit 32; and a memory 34, a decoder 36, a matrix keyboard unit 38, and a communication port 40 which are connected to the central control circuit unit 32. Further, the central control circuit unit 32 includes a CPU and peripheral circuits (a clock supply circuit, a reset circuit, a signal buffer, etc.). The memory 34 is composed of a ROM (Read Only Memory) or a flash memory, and a RAM (Random Access Memory). Programs executed by the CPU are stored into the ROM or flash memory, and the RAM is used as a data storage space and a stack for executing the programs. The memory 34 is connected with the central control circuit unit 32, the matrix keyboard unit 38, and the decoder 36. Thus, the memory 34 transmits/receives the data to/from the units 32, 38, 36 and receives control signals from the units.

The decoder 36 decodes address signals and the control signals, such as read and write signals, which are outputted from the CPU, and then generates signals for designating and controlling the memory and an input/output device. The matrix keyboard unit 38 is a keyboard laid out in the form of a matrix. The matrix keyboard unit 38 outputs key scan values and scan data showing positions and status of the pressed key buttons.

The communication port 40 is used to perform the data communication and to supply the electric power. The keyboard apparatus 12 is connected with the PDA 10 through the communication port so that a serial data communication can be performed through the port. For example, a communication scheme or method used in the port is a RS232C serial communication. Serial data signals and control signals for handshake are transmitted and received through the communication port 40. The electric power supplied from a main body of the PDA is supplied to internal circuits of the keyboard apparatus 12 through the communication port. The communication port 40 is provided with the connector 20. FIG. 4 shows a connection relationship between major components of the keyboard apparatus 12. In FIG. 4, each line with a slash marked thereon indicates that relevant components are connected with each other through a plurality of lines.

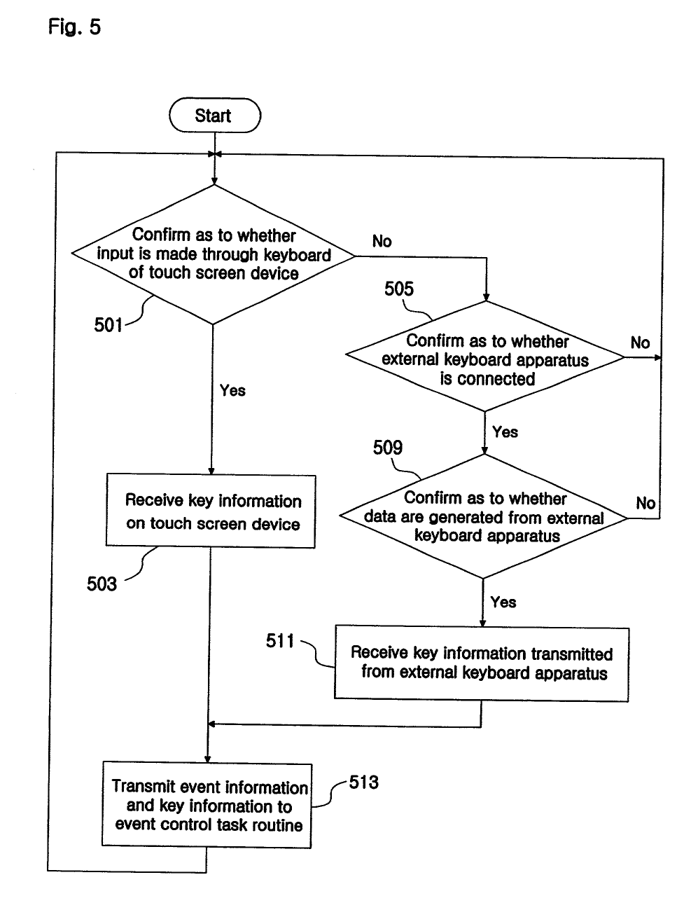

An operation of the keyboard apparatus 12 and the PDA 10 according to the preferred embodiment of the present invention will be explained below. FIG. 5 shows a process of receiving the key input through the BIOS of the PDA 10 in a state where the keyboard apparatus 12 is connected with the PDA 10. According to this process, the CPU executes a BIOS program stored in the storage device in a predetermined sequence. Referring to FIG. 5, it is first confirmed as to whether the key input is made through the touch screen device 14 of the PDA 10 (step 501). That is, it is confirmed as to whether the screen keyboard configured onto the touch screen device 14 has been touched or not. After the key touching or keying action has been recognized, key information on the touched relevant region of the screen keyboard is read (step 503).

If there is no key touching or keying action, it is confirmed as to whether the external keyboard apparatus is connected with the PDA based on RS232C control signals from the communication port (step 505). If the external keyboard apparatus is not connected with the PDA, the process is returned to a start step. Otherwise, it is confirmed as to whether the data are generated from the external keyboard apparatus 12 (step 509). If there are no generated data, the process is returned to the start step. Otherwise, the data on the key information are received (step 511). Finally, the key information and event information (information used for discriminating between an event of the screen keyboard and an event of the external keyboard apparatus) are transmitted to an event control task routine (step 513). In the event control task routine, a code mapping table is searched, and then, a code of the inputted key is found based on the information. A code value can be put or registered into an event queue of the activated application program (key input task) and processed in the application program.

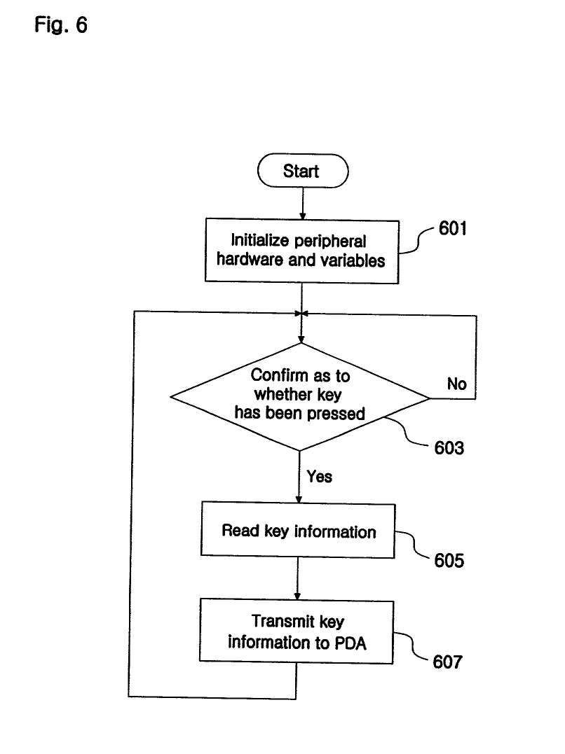

FIG. 6 shows an operation of the external keyboard apparatus 12. Referring to FIG. 6, when the external keyboard apparatus 12 is connected with the PDA 10, the CPU performs the operation according to sequences of the programs stored in the memory 34. First, peripheral hardware, variables used in the programs, and the like are initialized (step 601). Then, it is confirmed as to whether any keys have been pressed (step 603). If the keys are not pressed, it goes into a standby state. Otherwise, information on the touched keys such as the scan data and key scan values is read (step 605). The read key information is transmitted to the main body of the PDA (step 607).

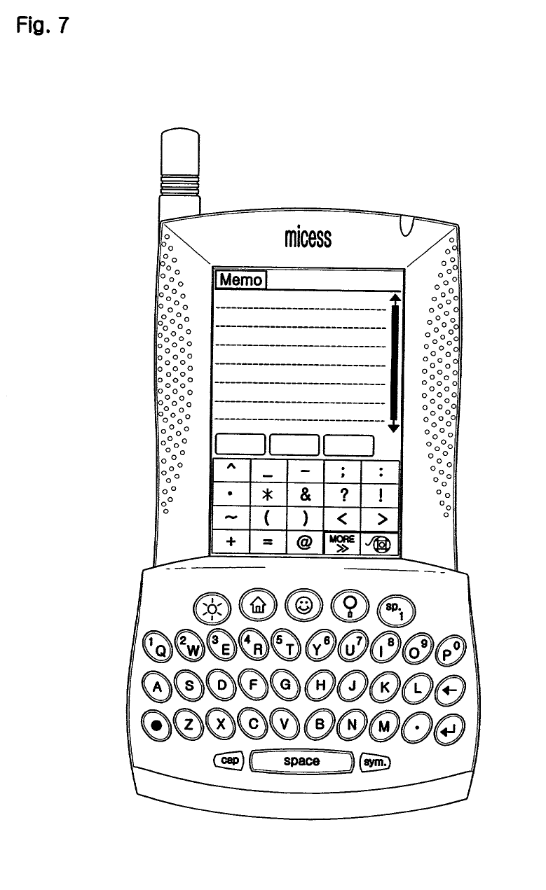

Furthermore, when the external keyboard apparatus 12 is engaged and connected with the PDA 10, the keyboard provided in the touch screen device 14 may be configured to complement the external keyboard apparatus 12. In other words, in a case where the keyboard apparatus 12 capable of inputting Korean/English alphabets is mounted into the PDA as shown in FIG. 1, the keyboard capable of inputting numbers may be set or configured in the touch screen device 14. To the contrary, in a case where the keyboard apparatus 12 capable of inputting English alphabets and numbers is installed as shown in FIG. 7, the keyboard capable of inputting the special symbols may be set or configured in the touch screen device 14 of the PDA 10.

Such settings or configurations may be made by the user's manual setting or configuration of the keyboard in a keyboard configuration menu of the touch screen device 14, which is provided from the operating system (OS) of the PDA 10. On the contrary, the screen keyboard may be automatically set or configured upon connection with the external keyboard apparatus 12. Such a process will be explained as an example. First, when the keyboard apparatus 12 is connected with the PDA, electric power is supplied to the keyboard apparatus 12. Then, the central control circuit unit 32 of the keyboard apparatus 12 transmits the information on the keyboard apparatus, which is stored in the memory 34 (for example, the information as to whether the keyboard apparatus is the Korean/English alphabet keyboard or the English alphabet/number keyboard), to the PDA through the communication port 40. The OS of the PDA 10 receives the information, retrieves the keyboard configuration data corresponding to the external keyboard apparatus 12 from the storage device or memory 34, and allows the data to be displayed onto the display panel of the touch screen device 14.

Accordingly, since the keyboard configurations of the touch screen device can be made to be adapted to the types or kinds of the keyboard apparatuses, the user can easily input the letters, numbers, special symbols, etc.

Although it has been described in the above embodiment of the present invention that the keyboard apparatus is used in the personal digital assistant (PDA), the present invention is not limited thereto. The keyboard apparatus of the present invention may be employed in different kinds of portable information systems such as a cellular phone.

According to the present invention, the external keyboard apparatus can be mounted into and utilized together with the portable information system such as the PDA. Since the external keyboard apparatus is small and can be connected directly to the portable information system without need to use the additional cable, the external keyboard apparatus is integrated into the portable information system. Then, the user can easily input desired texts through the keyboard apparatus even while holding the combined portable information system with his/her own hand. Accordingly, it is possible to eliminate the inconvenience in that the conventional keyboard apparatus connected with the conventional portable information system should be placed onto and utilized in a flat location.

In addition, the keyboard of the touch screen device provided in the main body of the portable information system can be configured to be complementary to the keyboard apparatus. Therefore, the letters, numbers, special symbols, etc. that the user wishes to input can be conveniently inputted without need to alternate the configuration of the keyboard displayed onto the touch screen device whenever the user intends to input them.

Although the present invention has been described in connection with the various embodiments, the present invention is not limited thereto. It is understood by those skilled in the art that various modifications and changes to the present invention may be made without departing from the spirit and scope of the invention, and these modifications and changes also fall within the scope of the present invention.

What is claimed is:

1. An input apparatus for use with an electronic device, comprising:
a housing comprising a surface and a structure configured to receive and engage with a portion of an electronic device;
a plurality of key buttons arranged on the surface of the housing, each key button being configured to generate an electrical signal when pressed; and
a connector disposed in the housing and configured to electrically connect with the electronic device so that the electrical signals generated in the apparatus can be transmitted to the electronic device.

2. The apparatus of claim 1, wherein the structure is configured to interlock with a mating structure of the electronic device.

3. The apparatus of claim 1, wherein the connector is configured to form a connection with the electronic device when the structure is engaged with the portion of the electronic device.

4. The apparatus of claim 1, further comprising a control circuit configured to control operation of transmission of electric signals.

5. The apparatus of claim 4, wherein the control circuit comprises a processor and a memory.

6. An input device for use with a hand-held computer, comprising:
means for holding a hand-held computer;
means for generating signals for alphanumeric characters; and
means for transferring the alphanumeric character signals to the hand-held computer while the hand-held computer is held by the holding means.

7. The input device of claim 6, wherein the holding means comprises a recess to receive a portion of the hand-held computer.

8. The input device of claim 6, wherein the holding means comprises a snap lock to interlock with a mating structure of the hand-held computer.

9. The input device of claim 6, wherein the signal generating means comprises a plurality of key buttons.

10. The input device of claim 6, wherein the signal transferring means comprises an electrical connector for connecting the input device with the hand-held computer.

11. The input device of claim 10, wherein the signal transferring means is configured to make a cordless connection between the input device and the hand-held computer.

12. A portable computer comprising:
a display unit comprising a display panel and a connector for connecting with an input device; and
a detachable keyboard comprising a mount for the display unit, wherein the mount comprising a connector configured to connect with the connector of the display unit.

13. The portable computer of claim 12, wherein the mount further comprises a structure configured to hold the display unit.

14. The portable computer of claim 12, wherein the display unit further comprises a portion shaped to be engaged with the mount.

15. The portable computer of claim 12, wherein the display unit further comprises a central control unit (CPU) and a memory connected to the CPU.

16. The portable computer of claim 12, wherein the display panel comprises a touch screen input device.

17. The portable computer of claim 12, wherein the display unit is programmed to receive inputs from the keyboard and from a touch screen.

18. The portable computer of claim 12, wherein the display unit is a hand-held computer.

19. The portable computer of claim 12, wherein when the display unit is connected to the keyboard, the display unit is configured to display keys not appearing in the keyboard for inputting by touching the screen.

20. A method of inputting data to an electronic device, comprising:
interlocking an input device comprising a plurality of key buttons with an electronic device comprising a display panel;
electrically connecting the input device and the electronic device; and
pressing a key button of the input device, thereby inputting a character or symbol corresponding to the pressed key button into the electronic device.

21. The method of claim 20, wherein the electrical connection is automatically carried out by the interlocking of the input device with the electronic device.

22. The method of claim 20, wherein when connecting the input device and electronic device, the display panel displays a plurality of keys for inputting by touching them, and wherein the plurality of keys displayed are those which are not available in the input device.

23. The method of claim 22, further comprising touching a key displayed on the display panel, thereby inputting a character or symbol corresponding to the touched key into the electronic device.
